(19) United States
(12) Patent Application Publication
(10) Pub. No.: US 2013/0326200 A1
(43) Pub. Date: Dec. 5, 2013

(54) INTEGRATED CIRCUIT DEVICES AND METHODS FOR SCHEDULING AND EXECUTING A RESTRICTED LOAD OPERATION

(71) Applicants: Amir Kleen, Herzliya (IL); Itzhak Barak, Kadima (IL); Yuval Peled, Kiryat Ono (IL); Idan Rozenberg, Raanana (IL); Doron Schupper, Rehovot (IL)

(72) Inventors: Amir Kleen, Herzliya (IL); Itzhak Barak, Kadima (IL); Yuval Peled, Kiryat Ono (IL); Idan Rozenberg, Raanana (IL); Doron Schupper, Rehovot (IL)

(73) Assignee: Freescale Semiconductor, Inc., Austin, TX (US)

(21) Appl. No.: 13/982,854

(22) PCT Filed: Feb. 11, 2011
(86) PCT No.: PCT/IB2011/050581

§ 371 Date: Jul. 31, 2013

(51) Int. Cl. G06F 9/30

(52) U.S. Cl. CPC G06F 9/30043
USPC 712/225

(57) ABSTRACT

An integrated circuit device comprising at least one instruction processing module arranged to compare validation data with data stored within a target register upon receipt of a load validation instruction. Wherein, the instruction processing module is further arranged to proceed with execution of a next sequential instruction if the validation data matches the stored data within the target register, and to load the validation data into the target register if the validation data does not match the stored data within the target register.

### FIELD OF THE INVENTION

The field of this invention relates to integrated circuit devices and methods for scheduling and executing a restricted load operation.

### BACKGROUND OF THE INVENTION

In the field of central processing unit (CPU) architectures and the like, and in particular for ‘in order’ pipelined CPU architectures, instruction scheduling is typically a compiler optimisation routing/process used to improve instruction level parallelism, which improves the performance of instruction processing architectures comprising instruction pipelines. Typically, instruction scheduling attempts to avoid pipeline stalls by re-arranging an order of instructions, and attempts to avoid illegal or semantically ambiguous operations (typically involving subtle instruction pipeline timing issues or non-interlocked resources), without changing the meaning of the application program code that is being compiled.

For conventional CPU architectures, compilers are typically restricted from cross block scheduling optimisations (i.e. scheduling optimisations between basic blocks of code within a program), in order to avoid violating un-optimised code exception behaviour. For example, FIG. 1 illustrates a simplified example of instruction execution flow 100. For the illustrated example, the instruction flow 100 comprises a conditional branch instruction 110 to (when a respective condition is met or not met) a separate block of code 120. For the illustrated example, this separate block of code 120 comprises a load instruction 130, a data usage instruction 140 and a state update (store) instruction 150. As the section of code after the branch instruction 110 is located within a separate (conditional) block of code 120, a scheduling restriction is created (illustrated generally at 160) across which instruction scheduling may not be performed (i.e. instructions located after this scheduling restriction 160 may not be scheduled to be performed alongside or before instructions located before the scheduling restriction 160), in order to avoid violating un-optimised code exception behaviour. As a result, because the load operation is not able to be scheduled before the scheduling restriction, a ‘stall’ is introduced into the instruction pipeline, illustrated generally at 170, whilst the data is loaded from memory (typically several execution cycles long). Accordingly, such scheduling restrictions significantly limit the optimisation that may be achieved for the execution of the code.

Furthermore, in conventional CPU architectures, compilers are also typically restricted from re-ordering read and write operations due to pointer ambiguity (e.g. in case of a write operation prematurely modifying a read area). For example, FIG. 2 illustrates a further known example of instruction execution flow 200. For the illustrated example, the instruction flow 200 comprises a write (store) operation 210 followed by a read (load) operation 230. In the case where these read and write operations 210, 230 correspond to the same area of memory, in order to avoid potentially incorrect data being read during the read operation 230, the read operation 230 is required to be performed after the write operation 210. Thus, a scheduling restriction is effectively created (illustrated generally at 260) across which instruction scheduling of the read operation 230 (and subsequent data usage operations 240) may not be performed. So, once again, as the load operation is not able to be scheduled before the scheduling restriction, a ‘stall’ is introduced into the instruction pipeline, illustrated generally at 270, whilst the data is loaded from memory, thereby significantly limiting the optimisation that may be achieved for the execution of the code.

Such restrictions in the ability to schedule the execution of instructions can have a significant detrimental effect on the efficiency with which the code may be executed by a CPU, and specifically can result in sub-optimal usage of the parallel processing capabilities of the CPU architecture.

### SUMMARY OF THE INVENTION

The present invention provides integrated circuit devices, a method for executing a restricted load operation and a method for scheduling a restricted load operation as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIGS. 1 and 2 illustrate known simplified examples of conventional instruction execution flows.

FIG. 3 illustrates a simplified block diagram of an example of part of an instruction processing module.

FIGS. 4 and 5 illustrate examples of scheduling restricted load operations.

FIG. 6 illustrates a simplified flowchart of an example of a method for execution of a restricted load operation.

FIG. 7 illustrates a simplified flowchart of an example of a method for scheduling a restricted load operation.

### DETAILED DESCRIPTION

Examples of the present invention will now be described with reference to an example of an instruction processing architecture, such as a central processing unit (CPU) architecture. However, it will be appreciated that the present invention is not limited to the specific instruction processing architecture herein described with reference to the accompanying drawings, and may equally be applied to alternative architectures. For the illustrated example, an instruction processing architecture is provided comprising separate data and address registers. However, it is contemplated in some examples that separate address registers need not be provided, with data registers being used to provide address storage. Furthermore, for the illustrated examples, the instruction processing architecture is shown as comprising four data execution units. Some examples of the present invention may equally be implemented within an instruction processing architecture comprising any number of data execution units. Additionally, because the illustrated example embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

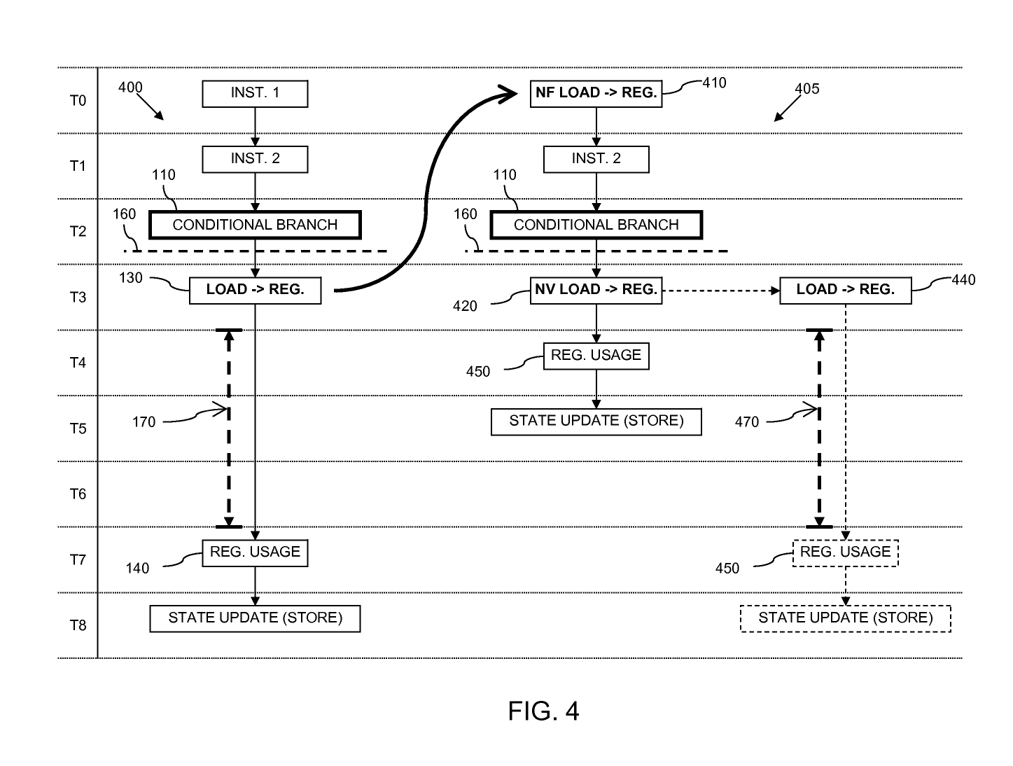

Referring first to FIG. 3, there is illustrated a simplified block diagram of an example of part of an instruction processing module 300 adapted in accordance with some example embodiments of the present invention. For the illustrated example, the instruction processing module 300 forms a part of an integrated circuit device, illustrated generally at 305, and comprises at least one program control unit (PCU) 310, one or more execution modules 320, at least one address generation unit (AGU) 330 and a plurality of data registers, illustrated generally at 340. The PCU 310 is arranged to receive instructions to be executed by the instruction processing module 300, and to cause an execution of operations within the instruction processing module 300 in accordance with the received instructions. For example, the PCU 310 may receive an instruction, for example stored within an instruction buffer (not shown), where the received instruction requires one or more operations to be performed on one or more bits/bytes/words/etc. of data. A data ‘bit’ typically refers to a single unit of binary data comprising either a logic ‘1’ or logic ‘0’, whilst a ‘byte; typically refers to a block of 8 bits. A data ‘word’ may comprise one or more bytes of data, for example two bytes (16 bits) of data, depending upon the particular DSP architecture. Upon receipt of such an instruction, the PCU 310 generates and outputs one or more micro-instructions and/or control signals to the various other components within the instruction processing module 300, in order for the required operations to be performed. The AGU 330 is arranged to generate address values for accessing system memory (not shown), and may comprise one or more address registers as illustrated generally at 335. The data registers 340 provide storage for data fetched from system memory 350, and on which one or more operation(s) is/are to be performed, and from which data may be written to system memory. The execution modules 320 are arranged to perform operations on data (either provided directly thereto or stored within the data registers 340) in accordance with micro-instructions and control signals received from the PCU 310. As such, the execution modules 320 may comprise arithmetic logic units (ALUs), etc.

As previously mentioned, scheduling restrictions can significantly limit the optimisation that may be achieved for the execution of instructions within an instruction processing module such as that illustrated in FIG. 3. Such scheduling restrictions may be a result of a need to avoid violating un-optimised code exception behaviour that may arise from cross block scheduling optimisations, pointer ambiguity caused by re-ordering read and write operations, etc. In accordance with some example embodiments of the present invention, an instruction set architecture of the instruction processing module 300 is arranged to comprise a load validation instruction for validating previously loaded data. In particular, the instruction processing module 300 is arranged, upon receipt of such a load validation instruction, to compare validation data with data stored within a target register, such as one of data registers 340. If the validation data matches the stored data within the target register 340, the instruction processing module 300 is arranged to proceed with execution of a next sequential instruction within the instruction sequence.

In this manner, data held within the target register 340 may be validated by comparing it to the validation data to determine whether or not the previously loaded data is still valid (e.g. has not been overwritten). As a result, a load operation for which a scheduling restriction exists (hereinafter referred to as a ‘restricted load’ operation) may be scheduled ahead of the scheduling restriction, whereby target data is scheduled to be loaded into the target register 340 ahead of the scheduling restriction within the instruction sequence. The load validation instruction may then be scheduled after the scheduling restriction (but before the target data is used) to validate the data within the target register 340 in order to determine whether, following the scheduling restriction, the data is still valid. If the stored data within the target register 340 is still valid (for example if the stored data within the target data matches the validation data), then the instruction processing module 300 may proceed with executing the next sequential instruction, for example in which the stored data is used. Thus, a more optimised scheduling of such restricted load operations may be performed, thereby enabling a more efficient execution of a respective instruction sequence. Furthermore, as will be appreciated by a skilled artisan, the use of such a load validation instruction in this manner substantially alleviates the need for complex validation mechanisms to be provided, and the need for speculative load operation data etc. to be maintained, within the instruction processing module 300.

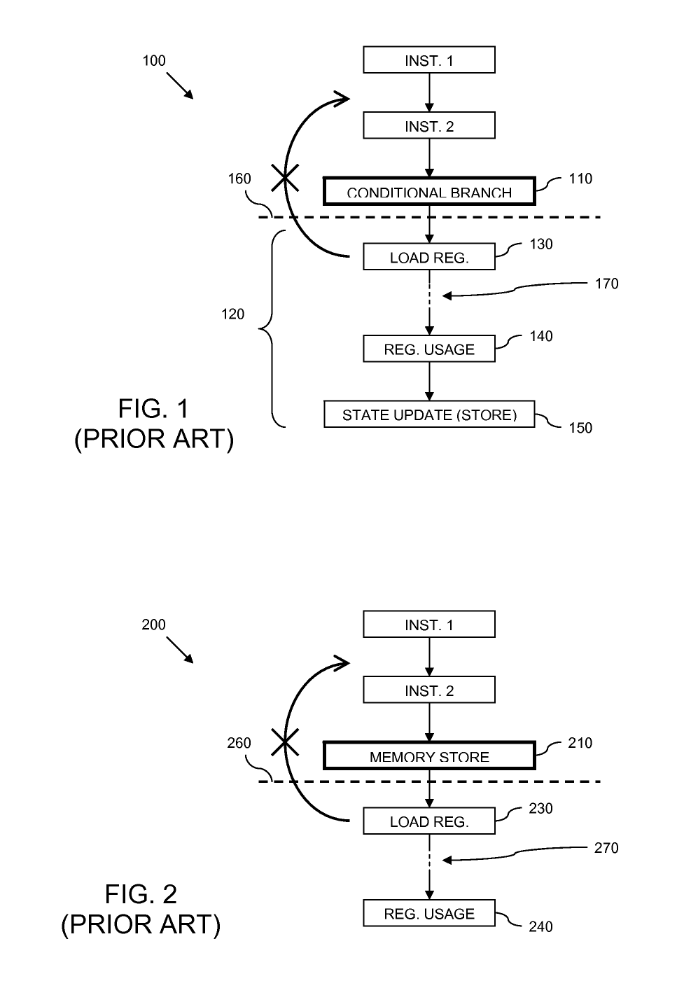

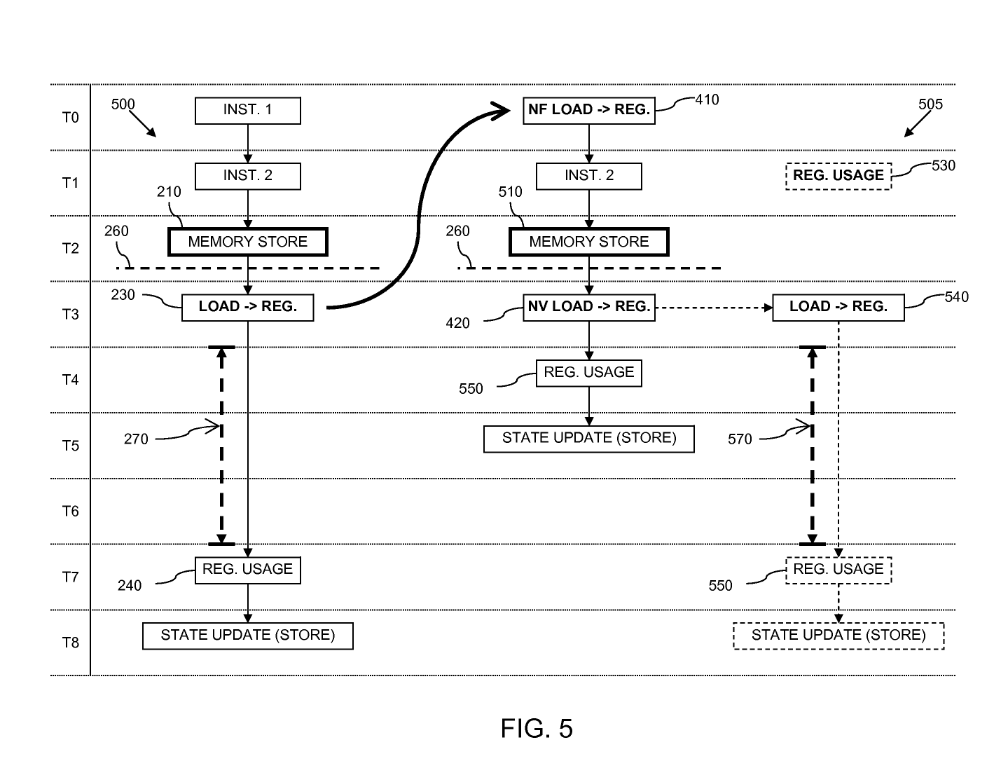

FIG. 4 illustrates an example of a scheduling of a restricted load operation within an instruction sequence that may be executed within an instruction processing module, such as the instruction processing module 300 of FIG. 3, in accordance with some example embodiments of the present invention. Specifically, FIG. 4 illustrates an example of a scheduling of a restricted load operation for which a scheduling restriction exists in a form of a conditional branch (e.g. a restriction of cross block scheduling). An instruction sequence for a conventional scheduling of such a restricted load operation is illustrated at 400, such as previously illustrated in FIG. 1. For this conventional instruction sequence 400, the restricted load operation is implemented by way of a conventional load instruction 130 scheduled within the instruction sequence 400 after the scheduling restriction, which for the example illustrated in FIG. 4 comprises conditional branch 110. As previously mentioned with reference to FIG. 1, as the section of code after the branch instruction 110 is located within a separate (conditional) block of code, a scheduling restriction is created (illustrated generally at 160) across which instruction scheduling is conventionally restricted in order to avoid violating un-optimised code exception behaviour. As a result, because the load instruction 130 is restricted from being scheduled ahead of the scheduling restriction 160, a ‘stall’ 170 is required to be introduced into the instruction pipeline before the data may be used (at 140), thereby allowing time for the data to be loaded from system memory 350. For the illustrated example, the ‘load to use’ penalty is assumed to be three execution cycles. Such a stall 170 may be implemented by way of, say, NOP instructions (not shown) or the like within the instruction sequence 400.

Conversely, for an example instruction sequence 405 scheduled in accordance with some example embodiments of the present invention, the restricted load operation may be initially implemented by way of an initial load instruction 410 that is scheduled ahead of the conditional branch 110 responsible for the scheduling restriction 160. In this manner, the operation of loading target data required for use after the scheduling restriction 160 is initiated in advance, in order to enable the data to be available for use without a need for introducing a stall 170 into the instruction pipeline. Additionally, a load validation instruction 420, as described above, is scheduled after the scheduling restriction 160 to validate the data stored within the target register 340. Assuming the target data loaded by the initial load instruction 410 has not be overwritten or the data in the target register 340 is otherwise not invalid, and thereby validated by the load validation instruction 420, the execution of the instruction sequence 405 proceeds on to the next sequential instruction 450, which for the illustrated example uses the target data within the target register. Significantly, and as illustrated in FIG. 4, as the initial load instruction 410 is able to be scheduled ahead of the scheduling restriction 160 (with the data subsequently being validated), the need for introducing a stall 170 into the instruction pipeline is substantially alleviated, thereby enabling a more efficient execution of instructions.

A risk of loading data ahead of the scheduling restriction 160 in this manner is that, in the case of such a scheduling restriction 160 being in the form of a conditional branch, an MMU (Memory Management Unit) may decide not to provide the data in response to the initial load instruction 410. As such, the data in the target register will subsequently not be valid; hence the provision of the load validation instruction 420. In such a case, where the data in the target register 340 is invalid, for example as a result of an MMU (not shown) not providing the data in response to the initial load instruction 410, the load validation instruction 420 may be arranged to cause the validation data to be written to the target register 340, as illustrated at 440. In this manner, the data in the target register 340 may be updated to comprise the correct data. Since the load validation instruction 420 will be required to retrieve the validation data from the system memory 350, it will experience a ‘load to use’ penalty of, in this example, three execution cycles. As a result, any subsequent instructions within the instruction pipeline may have already accessed the invalid data before the data has been (in)validated. In the case where the stored data within the target register 340 is valid, execution of the subsequent sequential instructions within the instruction sequence 405 may be allowed to continue. However, in the case where the stored data within the target register 340 is invalid, the load validation instruction 420 may be further arranged to cause the instruction pipeline to be ‘flushed’, and for the execution flow to restart from, say, the next sequential instruction 450 within the instruction sequence 405 following the load validation instruction 420.

In this manner, corrupt execution of subsequent instructions based on the invalid data may be purged from the instruction pipeline. Although such a flushing of the instruction pipeline will result in a stall whilst subsequent instructions propagate through the instruction pipeline, as illustrated at 470, such a stall 470 is comparable to the stall 170 within the conventional instruction sequence 400. However, as illustrated in FIG. 4, such a stall 470 is advantageously only experienced in the instruction sequence 405 of the present invention when the stored data in the target register is invalid.

For some example embodiments of the present invention, the initial load instruction 410 may be arranged to cause, for the illustrated example, the instruction processing module 300 to disregard memory management error indications. In some examples, the instruction processing module 300 may disregard memory management error by blocking data reaching the core/target register 340. For example, MMUs (memory management units) are responsible for memory protection and translation services for the CPU. Typically, memory errors are received predominantly for a memory access to areas that the running task either does not have translation for, or to areas that an Operating system (OS) has defined such a task as not being allowed access to. In the context of software speculation, such as hereinbefore described, a speculated memory load (e.g. the initial load initiated by initial load instruction 410) can be from a non-initialized pointer with an undefined value. As a result it is likely to generate a memory error.

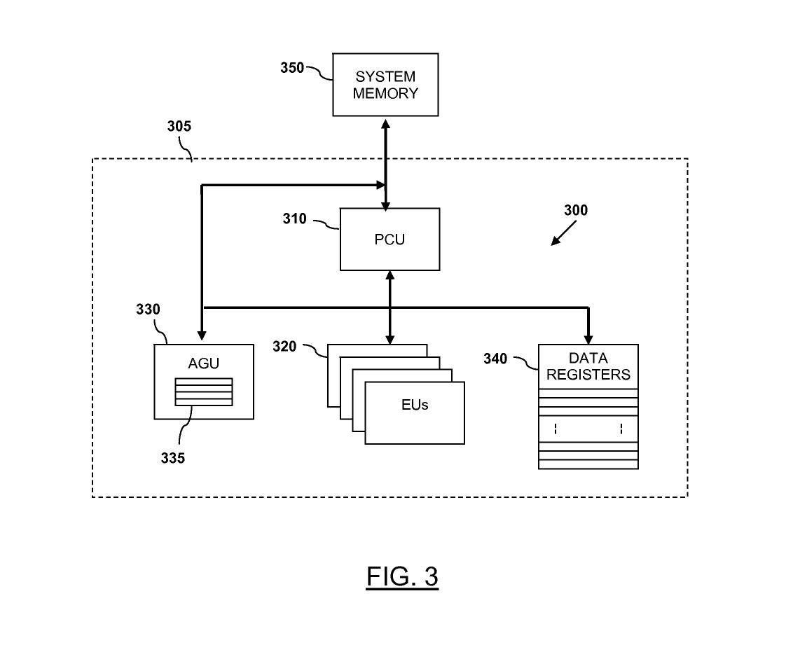

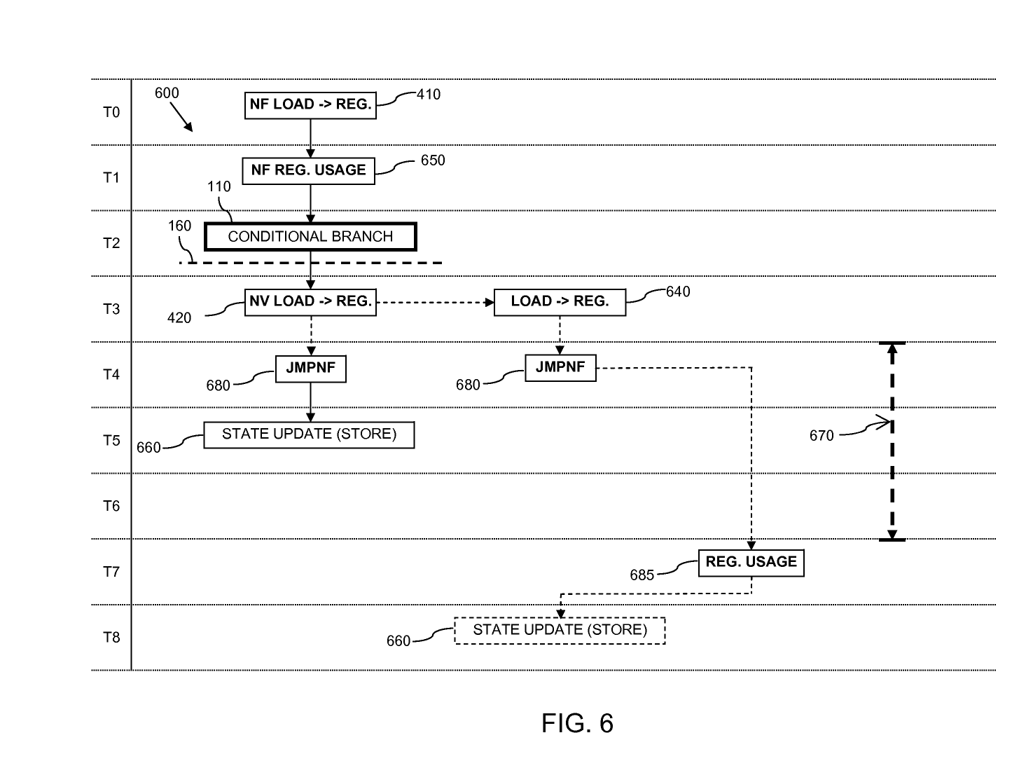

FIG. 5 illustrates a further example of a scheduling of a restricted load operation within an instruction sequence executed within, say, the instruction processing module 300 FIG. 3. Specifically, FIG. 5 illustrates an example of a scheduling of a restricted load operation for which a scheduling restriction exists in a form of a write (store) operation. An instruction sequence for a conventional scheduling of such a restricted load operation is illustrated at 500, such as previously illustrated in FIG. 2. Once again, the restricted load operation is implemented by way of a conventional load instruction 230 scheduled within the instruction sequence 500 after the scheduling restriction, which for the example illustrated in FIG. 5 comprises memory store operation 210. As previously mentioned with reference to FIG. 2, in the case where these read (load) and write (store) operations 230, 210 correspond to the same area of system memory 350, in order to avoid potentially incorrect data being read during the load operation 230, the load operation 230 is conventionally required to be performed after the store operation 210. Thus, a scheduling restriction is created (illustrated generally at 260) across which instruction scheduling of the load operation 230 (and subsequent data usage operations 240) may not conventionally be performed. So once again, because the load operation 230 is not able to be scheduled before the scheduling restriction 260, a stall is introduced into the instruction pipeline before the data may be used (at 240), thereby allowing time for the data to be loaded from system memory 350.

Conversely, for an example instruction sequence 505 scheduled in accordance with some example embodiments of the present invention, the restricted load operation may be once again initially implemented by way of an initial load instruction 410 that is scheduled ahead of the store (write) operation 210 responsible for the scheduling restriction 260. In this manner, the operation of loading target data required for use after the scheduling restriction 260 is initiated in advance in order to enable the data to be available for use without a need for introducing a stall 270 into the instruction pipeline. Additionally, a load validation instruction 420 is scheduled after the scheduling restriction 260 to validate the data stored within the target register 340. As for the example illustrated in FIG. 4, if the stored data within the target register is validated (e.g. matches the validation data), execution of the instruction sequence 405 proceeds on to the next sequential instruction 550. Conversely, if the stored data within the target register is invalid, for example as a result of the data being overwritten as illustrated at 530, the load validation instruction 420 may cause the validation data to be written to the target register, as illustrated at 540, thereby updating the data in the target register 340 to comprise the correct data. The instruction pipeline may then be ‘flushed’, and the execution flow re-started from, say, the next sequential instruction 550 within the instruction sequence 505.

For the examples illustrated in FIGS. 4 and 5, only a load operation, in a form of the initial load instruction 410, has been speculatively scheduled ahead of the scheduling restriction 160, with the subsequent usage of the data being scheduled after the scheduling restriction, as illustrated generally at 450 and 550 respectively.

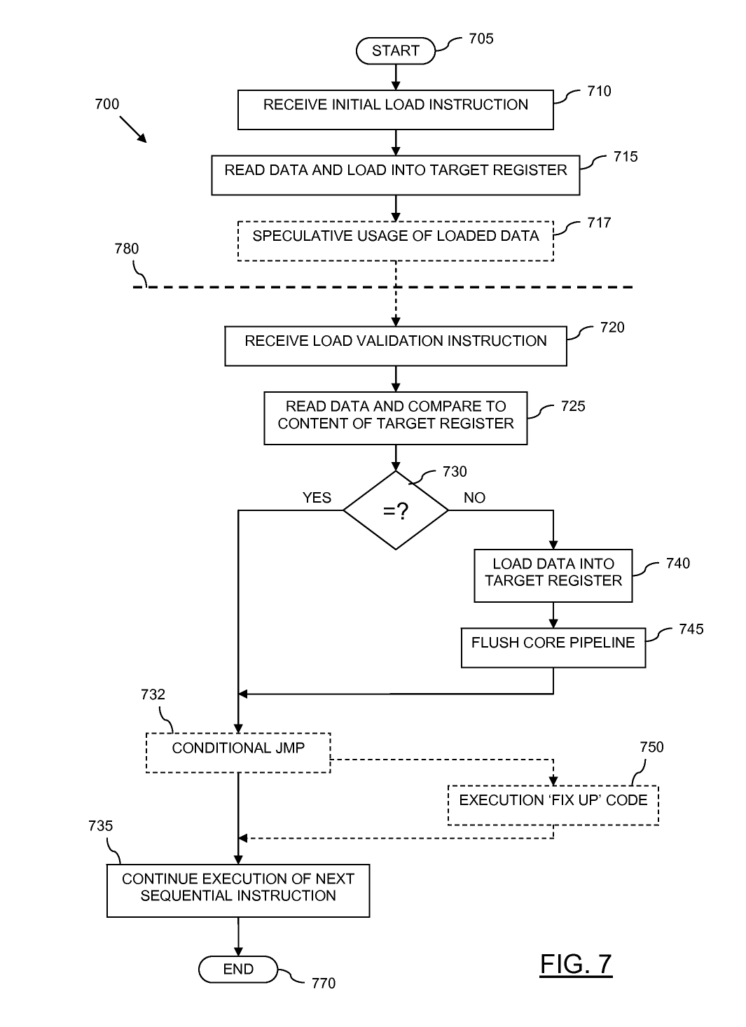

FIG. 6 illustrates a further example of a scheduling of a restricted load operation within an instruction sequence that may be executed within an instruction process module, such as the instruction processing module 300 of FIG. 3, in accordance with further example embodiments of the present invention. For the example illustrated in FIG. 6, not only is a load operation, in the form of initial load instruction 410, speculatively scheduled ahead of the a scheduling restriction 160, but also a subsequent usage of the data to be speculatively loaded, as illustrated at 650. A conditional jump instruction 680 may also be scheduled into the instruction sequence, in parallel with or immediately following the load validation instruction. More specifically, FIG. 6 illustrates an alternative example of an instruction scheduling of a restricted load operation for which a scheduling restriction exists in a form of a conditional branch 110 (e.g. a restriction of cross block scheduling). As illustrated, the restricted load operation is initially implemented by way of initial load instruction 410 for loading data into a target register 340, and which is scheduled ahead of the conditional branch 110 that is responsible for the scheduling restriction 160. Additionally, illustrated at 650, an instruction using the data to be fetched within the initial load instruction 410 is also scheduled ahead of the conditional branch 110 that is responsible for the scheduling restriction 160. In the same manner as for FIGS. 4 and 5, a load validation instruction 420 is scheduled after the scheduling restriction 160 in order to validate the data stored within the target register 340. For the example illustrated in FIG. 6, the load validation instruction 420 may also be arranged to cause the instruction processing module 300 to set, say, a conditional bit within a register, in accordance with the validation of the data stored within the target register 340. Assuming that the target data loaded by the initial load instruction 410 has not been over-written, or the data in the target register 340 is otherwise not invalid and thereby validated by the load instruction 420, the execution of the instruction sequence 600 proceeds to the next sequential instruction 680, which for the illustrated example comprises the conditional jump instruction. Since the data in the target register 340 was successfully validated, the conditional bit set by the load validation instruction may cause the conditional jump instruction 680 not to be executed, thereby resulting in the execution of the instruction sequence 600 proceeding to the next sequential instruction 660, comprising a state update (store) instruction.

However, if the data in the target register 340 is invalid, for example as a result of, say, an MMU (not shown) not providing the data in response to the initial load instruction 410, the load validation instruction 420 may be arranged to cause the validation data to be written to the target register 340, as illustrated at 640. In this manner, the data in the target register 340 may be updated to comprise the correct data. As previously mentioned, since the load validation instruction 420 will be required to retrieve the validation data from the system memory 350, it will experience a ‘load to use’ penalty of, in this example, three execution cycles 670. As a result, any subsequent instructions within the instruction pipeline may have already accessed the invalid data before the data has been (in)validated. Thus, in the case where the stored data within the target register 340 is invalid, the load validation instruction 420 may be further arranged to cause the instruction pipeline to be ‘flushed’.

As will be appreciated, the previously executed usage instruction 650, which may have used the invalid data, will be required to be re-executed following the instruction pipeline being flushed. Accordingly, in one example, the load validation instruction 420 may be arranged, following the instruction pipeline being flushed, to cause a re-execution of the speculatively scheduled usage instruction 650, as illustrated at 685. Such an operation may be performed prior to the execution flow re-starting from, say, the next sequential instruction 450 within the instruction sequence 405 following the load validation instruction 420. Thus, for the example illustrated in FIG. 6, where a speculative use of data loaded by the initial load instruction has occurred prior to the scheduling restriction 160, if the data in the target register 340 was not validated by the load validation instruction 420, the conditional bit set by the load validation instruction 420 may cause the conditional jump instruction 680 to be executed, resulting in a change of flow within the execution of the instruction sequence 600 to a ‘fix-up’ code snippet. The ‘fix-up’ code snippet causes the re- execution of the speculatively scheduled usage instruction 650, as illustrated at 685. The instruction flow may then return to the next sequential instruction, which for the illustrated example comprises the state update (store) instruction 660.

FIGS. 4, 5 and 6 illustrate two examples of scheduling restrictions, namely as a result of a conditional branch operation 110 and a memory store (write) operation 210. It will be appreciated that these are only intended as examples of causes of scheduling restrictions, and alternative causes of scheduling restrictions may exist within some instruction processing architectures.

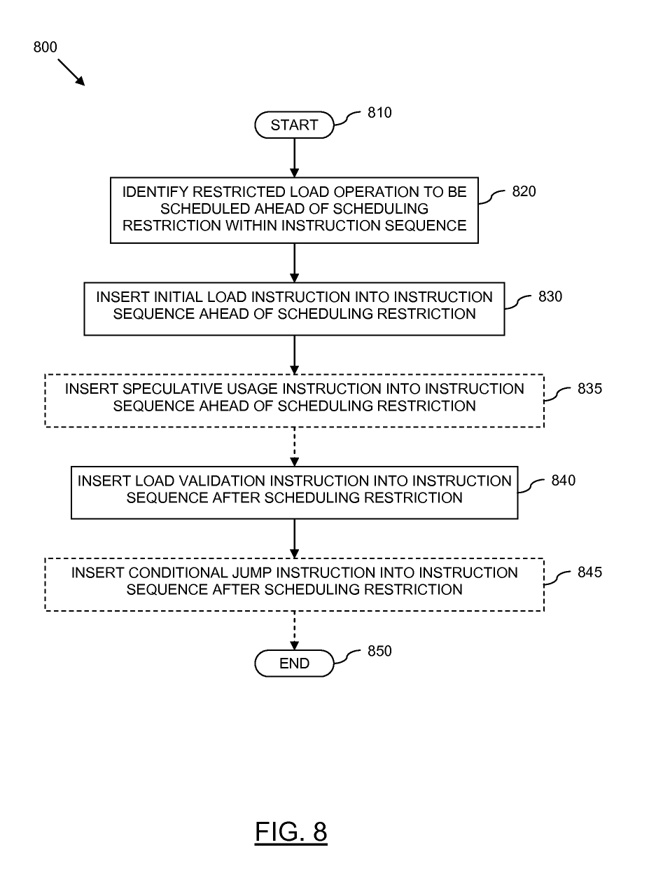

Referring now to FIG. 7, there is illustrated a simplified flowchart 700 of an example of a method for execution of a restricted load operation, for example as may be implemented within the instruction processing module 300 of FIG. 3. The method starts at 705, and moves on to 710 with a receipt of an initial load instruction, such as the initial load instruction 410 illustrated in FIGS. 4, 5 and 6. Data is then read from system memory and loaded into a target register in accordance with the received initial load instruction, at 715. In accordance with some examples of the present invention, a speculative usage of the data within the target register may (optionally) occur, as illustrated generally at 717, for example in response to the receipt of a data usage instruction (not shown). Subsequently, for example following a scheduling restriction as illustrated generally at 780, the method comprises receiving a load validation instruction, such as the load validation instruction 420 illustrated in FIGS. 4, 5 and 6, at 720. Validation data is then read from system memory in accordance with the load validation instruction, and compared to the content of the target register at 725, for example to determine whether the data within the target register is still valid. If, at 730, it is determined that the data within the target register matches the read validation data, it may be assumed that the content of the target register is valid (e.g. has not been over-written or otherwise compromised), and the method moves on to 735 with the continued execution of the next sequential instruction. The method then ends at 770. In accordance with some examples of the present invention, following a speculative usage of the data within the target register ahead of the scheduling restriction 780, such as data usage 717, a conditional jump instruction may (optionally) be received following (or in parallel with) the load validation instruction, as illustrated at 732. The conditional jump instruction 732 may be conditional based on, say, a bit set within a register by the load validation instruction 720. In the case where the data within the target register is validated, the load validation instruction 720 may cause the conditional bit to be set such that the conditional jump instruction is not executed, and the method moves on to 735 with the continued execution of the next sequential instruction.

Conversely, if, at 730, it is determined that the data within the target register does not match the read validation data, the method moves on to 740 where, the validation data is loaded into the target register, over-writing the previous (invalid) data stored therein. An instruction execution core pipeline is the flushed, at 745, in order to purge corrupt execution of subsequent instructions based on the invalid data from the instruction pipeline. The method may then move on to 735 with the continued execution of the next sequential instruction, before ending at 770. However, as previously mentioned, following a speculative usage of the data within the target register ahead of the scheduling restriction 780, such as data usage 717, a conditional jump instruction 732 may (optionally) be received following (or in parallel with) the load validation instruction. Accordingly, following the instruction execution core pipeline being flushed at 745, the method may return to the conditional jump instruction 732. In such a case, the load validation instruction 720 may cause the conditional bit to be set such that the conditional jump instruction is executed, resulting in a change of flow within the execution of the instruction sequence to a ‘fix-up’ code snippet 750, which may cause a re-execution of the speculatively scheduled usage 717. The method may then return to the execution of the next sequential instruction at 735, and end at 770.

Referring now to FIG. 8, there is illustrated a simplified flowchart 800 of an example of a method for scheduling a restricted load operation within an instruction sequence for execution by an instruction processing module, for example as may be implemented by a user or within a compiler or the like. The method starts at 810, and moves on to 820 comprising identifying a restricted load operation to be scheduled ahead of a scheduling restriction within an instruction sequence. Next, at 830, an initial load instruction for the restricted load operation is inserted ahead of the scheduling restriction within the instruction sequence. Optionally, a speculative usage instruction may be inserted after the initial load instruction, but ahead of the scheduling restriction within the instruction sequence, as illustrated at 835. A load validation instruction may then be inserted into the instruction sequence after the scheduling restriction at 840. Optionally, for example if a speculative usage instruction has been inserted as illustrated at 835, a conditional jump instruction (for example conditional on a bit set by the load validation instruction) may be inserted into the instruction sequence just after (or in parallel with) the load validation instruction, as illustrated at 845. The method then ends at 850.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Specifically, the present invention is not limited to the particular instruction processing architecture illustrated in FIG. 3, but may equally be implemented within any alternative architectural implementation.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising:
at least one instruction processing module arranged to compare validation data with data stored within a target register upon receipt of a load validation instruction;
wherein the instruction processing module is further arranged to: proceed with execution of a next sequential instruction if the validation data matches the stored data within the target register, and load the validation data into the target register if the validation data does not match the stored data within the target register.

2. The integrated circuit device of claim 1 wherein the at least one instruction processing module is further arranged to flush an instruction pipeline thereof if the validation data does not match the stored data.

3. The integrated circuit device of claim 1 wherein the instruction processing module is arranged to disregard memory management error indications upon receipt of an initial load instruction.

4. The integrated circuit device of claim 3 wherein the instruction processing module is arranged to disregard memory management error by blocking data reaching the target register.

5. A method for executing a restricted load operation, the method comprising, within an instruction processing module:
receiving a load validation instruction; and
comparing validation data with data stored within a target register;
proceeding with execution of a next sequential instruction if the validation data matches the stored data within the target register; and
load the validation data into the target register if the validation data does not match the stored data within the target register.

6. The method of claim 5 wherein the method further comprises flushing an instruction pipeline thereof if the validation data does not match the stored data.

7. A method for scheduling a restricted load operation, the method comprising:
identifying at least one restricted load operation to be scheduled ahead of a scheduling restriction within an instruction sequence for execution by at least one instruction processing module;
inserting an initial load instruction for the restricted load operation ahead of the scheduling restriction within the instruction sequence; and inserting a load validation instruction into the instruction sequence after the scheduling restriction.

8. The method of claim 7 wherein the load validation instruction is arranged to cause the instruction processing module to compare validation data with data stored within a target register and to:
proceed with execution of a next sequential instruction if the validation data matches the stored data within the target register; and
load the validation data into the target register if the validation data does not match the stored data within the target register.

9. The method of claim 8 wherein the load validation instruction is further arranged to cause the instruction processing module to flush an instruction pipeline thereof if the validation data does not match the stored data.

10. The method of claim 7 wherein the method further comprises inserting a data usage instruction into the instruction sequence after the initial load instruction and ahead of the scheduling restriction, the data usage instruction being arranged to cause the instruction processing module to use data stored within the target.

11. The method of claim 10 wherein the method further comprises inserting a conditional jump instruction into the instruction sequence in parallel with or immediately following the load validation instruction, the conditional jump instruction being arranged to cause the instruction processing module to cause a change of flow to re-execute the speculatively scheduled usage instruction if the validation data does not match the stored data within the target register.

12. The method of claim 7 wherein the initial load instruction is arranged to cause the instruction processing module to disregard memory management error.

13. The integrated circuit device of claim 2 wherein the instruction processing module is arranged to disregard memory management error indications upon receipt of an initial load instruction.

14. The method of claim 8 wherein the method further comprises inserting a data usage instruction into the instruction sequence after the initial load instruction and ahead of the scheduling restriction, the data usage instruction being arranged to cause the instruction processing module to use data stored within the target.

15. The method of claim 9 wherein the method further comprises inserting a data usage instruction into the instruction sequence after the initial load instruction and ahead of the scheduling restriction, the data usage instruction being arranged to cause the instruction processing module to use data stored within the target.

16. The method of claim 8 wherein the initial load instruction is arranged to cause the instruction processing module to disregard memory management error.

17. The method of claim 9 wherein the initial load instruction is arranged to cause the instruction processing module to disregard memory management error.

18. The method of claim 10 wherein the initial load instruction is arranged to cause the instruction processing module to disregard memory management error.

19. The method of claim 11 wherein the initial load instruction is arranged to cause the instruction processing module to disregard memory management error.
